(19) United States
(12) Patent Application Publication
(10) Pub. No.: US 2006/0285167 A1
(43) Pub. Date: Dec. 21, 2006

(54) Image processing method and a recording medium storing image processing program

(75) Inventor: Koji Washio, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/226,773

(22) Filed: Sep. 14, 2005

(30) Foreign Application Priority Data
Jun. 17, 2005 (JP) 2005-177704

(51) Int. Cl. G06K 15/00

(52) U.S. Cl. 358/3.14; 358/3.13; 358/3.06

(57) ABSTRACT

Disclosed is an image processing method that includes: discriminating whether a target pixel of an image to be processed is a contour pixel which is part of a contour of an object; and determining, in case of discriminating that the target pixel is a contour pixel, an output value of the target pixel by referring to an output value that is obtained by applying a threshold for a dither process corresponding to a pixel outside the object to a pixel value of the target pixel and referring to the output value.

### BACKGROUND OF THE INVENTION

1. Field of the Invention

This invention relates to an image processing method and a recording medium storing an image processing program and, more particularly, to an image processing method and a recording medium storing image processing program for properly processing contour portions of an object.

2. Description of Related Art

With printers and the like in which a regular or systematic screen pattern is used, dotting is performed every predetermined number of pixels (a spot formed by using such a screen pattern is referred to as a dot). When a dither process is performed in such a printer to represent a letter image in a halftone, a phenomenon which is called a jaggy and in which a contour portion (i.e., an outline portion) of the letter looks to be jagged may occur or part of the letter may be thinned, as shown in FIG. 9, because of the difference between the angle of a contour line of the letter image and a screen angle. If such degradation in image quality makes it difficult to identify a contour portion of the letter, the apparent resolution of the letter image lowers, resulting in lower visibility.

For example, if a dither process is performed on an image of the letter “T” shown in FIG. 10A to reproduce it with intermediate density, then an output result shown in FIG. 10B is obtained. In FIG. 10B, a dotted line indicates a contour line. As shown in FIG. 10B, in a horizontal line portion of “T” dots are outputted in some contour portions and are not outputted in others. As a result, a jaggy phenomenon has occurred. In addition, in a contour portion of a vertical line of “T” thinning has occurred, so the shape of the original letter cannot be reproduced accurately.

To solve these problems which arise in contour portions, a method for determining the characteristics (indicative of an image type such as a character, a graphic, or a photograph drawing) of each pixel from information described in a page description language (PDL) and for performing image processing according to the characteristics has conventionally been disclosed (see, for example, JP-Tokukai-Hei-9-282471A). According to the method disclosed in JP-Tokukai-Hei-9-282471A, a TEXT signal indicative of a letter is generated for a pixel in an image area including, for example, a letter for which importance is attached to resolution. At image processing time, a high-resolution screen, such as a 400-line single line screen, is used for the image area in which the TEXT signal is set, and a low-resolution screen, such as a 200-line single line screen, is used for the other areas. The screens which differ in resolution are used in this way for avoiding degradation in the resolution of a letter area.

If the angle of a contour line approximates to a screen angle, intervals at which dots are outputted are long in a contour portion. As a result, a jaggy appears in a long cycle and is very noticeable. As shown in FIG. 11A, for example, such a problem arises in the case where a 90-degree single line screen is used for a contour line the angle of which approximates to 90 degrees. To solve this problem, it is effective to control the angle of the contour line not to approximate to the screen angle thus shorting the cycle of the jaggy. For example, a O-degree single line screen is preferably used.

A technique for extracting contour portions included in an image on the basis of a PDL, for performing a dither process on a non-contour area by using a single line screen, and for performing, for example, a diffusion dither process which is a kind of dither process and in which no angle is required on a contour area or exercising control, by performing a dither process on a contour area by the use of a single line screen having a screen angle other than an ordinary screen angle according to the angle of a contour, so as to prevent the angle of the contour from approximating to the screen angle is disclosed as one of such methods (see, for example, JP-Tokukai-2004-40499A).

With some printers, however, at the stage of printing out density may differ according to the relative positions of two or more dots formed by ink or toner. For example, the total of the toner densities of two dots adjacent to each other may differ from the total of the toner densities of two dots distant from each other due to the frequency response characteristics of a printer. That is to say, when one dot is formed, the printer responds slowly and the amount of toner or the like outputted is small. On the other hand, when two dots are formed in succession, the printer responds quickly and the amount of the toner or the like outputted increases. However, output characteristics differ among different printers in degree.

With the technique disclosed in JP-Tokukai-2004-40499A, another dither process is performed on the contour portions. As a result, in some cases a phenomenon in which dots outputted in the contour portions by using the different screen patterns are locally touching or separate occurs periodically.

As can be seen from FIG. 11A, for example, if a dither process is performed on the non-contour area by using a 90-degree single line screen and a dither process is performed on the contour area by using a O-degree single line screen, a phenomenon in which dots formed in a contour portion by using the different single line screens are locally touching or separate occurs at regular intervals.

When the above output characteristics of printers are taken into consideration, the density of a portion in which dots are touching becomes high. If the contour area is studded with high density portions at regular intervals or randomly, then a jaggy appears and image quality may be degraded. Intervals at which dots are touching are long when the screen angle of a single line screen used for performing a dither process on the non-contour area approximates to the angle of a contour portion. In this case, a jaggy is very noticeable.

A contone process may be performed on the contour area to add a contour line. However, the problem of the appearance of a jaggy as a result of a contour line and a dot being touching at regular intervals cannot be solved. Moreover, such a technique can be applied only to cases where a single line screen is used, and cannot be applied to cases where a dot screen is used. Even if a dither process is performed on the contour area by using a dot screen the screen angle which differs from that of a dot screen used for performing a dither process on the non-contour area, the same problem that arises in the case of using a single line screen will turn up. That is to say, as shown in FIG. 11B, a phenomenon in which dots formed in a contour portion by using the different screens are locally touching or separate occurs at regular intervals.

### SUMMARY OF THE INVENTION

An object of the present invention is to enhance contour portions (i.e., outline portions) without degrading image quality.

To achieve the above object, in accordance with an embodiment reflecting the first aspect of the present invention, an image processing method comprises:

discriminating whether a target pixel of an image to be processed is a contour pixel which is part of a contour of an object; and

determining, in case of discriminating that the target pixel is a couture pixel, an output value of the target pixel by referring to an output value that is obtained by applying a threshold for a dither process corresponding to a pixel outside the object to a pixel value of the target pixel.

In accordance with an embodiment reflecting the second aspect of the invention, a recording medium storing an image processing program causes a computer to execute a method comprising:

discriminating whether a target pixel of an image to be processed is a contour pixel which is part of a contour of an object; and

determining, in case of discriminating that the target pixel is a couture pixel, an output value of the target pixel by referring to an output value that is obtained by applying a threshold for a dither process corresponding to a pixel outside the object to a pixel value of the target pixel.

In either of the embodiments reflecting the first and second aspects of the present invention, it is preferable that, in the discriminating, whether the target pixel is a contour pixel which constitutes a part of the contour of the object or not is discriminated based on the pixel value of the target pixel and a pixel value of a surrounding pixel for the target pixel.

Preferably, in the determining of either of the above mentioned embodiments, an output value is obtained by applying a threshold for a dither process corresponding to the target pixel and is determined as the output value of the target pixel, in the case of discriminating that the target pixel is not a contour pixel.

Preferably, in the determining of either of the above mentioned embodiments,

a plurality of output values are obtained by applying thresholds for a dither process corresponding to a plurality of pixels outside the object, and

an output value of the target pixel is determined by referring to an operation result obtained by a simple mean value, a weighted mean value or a maximum value of the plurality of output values, or combination thereof.

Preferably, either of the above mentioned embodiments further comprises inputting an image identification signal indicative of a type of the image including the target pixel,

wherein the determining is performed only on a target pixel for which the image identification signal is a specific signal.

Preferably, either of the above mentioned embodiments further comprises inputting the pixel value of the target pixel,

wherein the determining is performed only when the pixel value of the target pixel is greater than or equal to a certain value.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein:

FIG. 1 is a view showing the internal structure of an image processing apparatus according to an embodiment of the present invention;

FIG. 2 is a view showing an example of a screen cell used for performing a dither process;

FIG. 3 is a view showing a threshold function set for a cell element;

FIG. 4 is a view showing the relationships among threshold functions set for cell elements;

FIG. 5 is a flow chart for describing the flow of a process performed by a contour processing section;

FIG. 6 is a view showing an example of a template pattern;

FIGS. 7A, 7B, and 7C are views showing examples of output obtained by a contour enhancement process;

FIGS. 8A and 8B are views showing examples of output obtained by a contour enhancement process;

FIG. 9 is a view for describing a jaggy which appears as a result of a conventional dither process;

FIGS. 10A and 10B are views showing an example of image degradation caused by a conventional dither process; and

FIGS. 11A and 11B are views for describing methods for eliminating a jaggy by conventional techniques.

### DETAILED DESCRIPTION OF THE PREFERRED EMBODIMENTS

An embodiment of the present invention will now be described with reference to the drawings.

Structure will be described first.

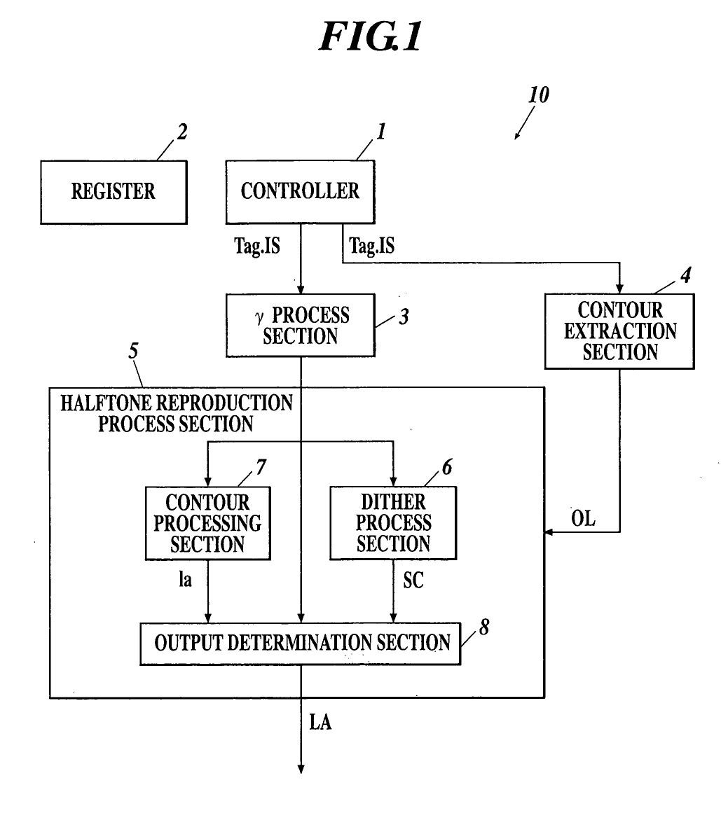

FIG. 1 is a block diagram showing the internal structure of an image processing apparatus 10 according to an embodiment of the present invention.

As shown in FIG. 1, the image processing apparatus 10 comprises a controller 1, a register 2, a γ process section 3, a contour extraction section 4, and a halftone reproduction process section 5.

The controller 1 receives input image data Im to be processed and PDL data from the outside and generates image data IS for each pixel by performing a rasterizing process. The image data IS may be color-converted according to color materials (in this example, the four colors of yellow (Y), magenta (M), cyan (C), and black (K)) used at the time of printing out.

In addition, the controller 1 generates an image identification signal Tag on the basis of the PDL data. Tag is one of: Image which indicates that a pixel is included in a photograph drawing; Text which indicates that a pixel is included in a character; and Graphic which indicates that a pixel is included in a line drawing.

The image data IS and the image identification signal Tag generated are outputted to the γ process section 3 and the contour extraction section 4 at timing controlled via a line buffer (not shown).

The register 2 stores data, such as parameters and look-up tables (LUTs), which is necessary for the γ process section 3, the halftone reproduction process section 5, etc. to perform a process and provides it in response to a read request from each section.

The γ process section 3 makes a γ correction of the image data IS inputted by using an LUT for γ correction.

The contour extraction section 4 detects pixels which form the contour of a character or a line drawing (hereinafter referred to as an object) from the image data IS inputted. The contour extraction section 4 generates contour information OL indicative of whether it is a pixel (hereinafter referred to as a contour pixel) which is part of the contour for each of all pixels included in the image data IS and outputs the contour information OL to the halftone reproduction process section 5. The contour information OL will be used for a contour enhancement process performed later. In the contour enhancement process, contour portions of the object the density of which is higher than that of a background are to be processed. Therefore, the contour pixels detected by the contour extraction section 4 form the contour of the object the density of which is higher than that of the background.

How to generate the contour information OL will now be described.

A target pixel is set in order of the image data IS inputted. On the basis of Tag inputted with the target pixel, whether the target pixel is included in the object is determined. If Tag is Text or Graphic and the determination that the target pixel is included in the object is made, then the difference between the pixel value of the target pixel and the pixel value of a surrounding pixel adjacent thereto is found. If the difference is greater than or equal to a threshold set in advance for detecting a contour pixel, then the determination that the target pixel is a contour pixel is made. Only contour pixels which form the contour of the object the density of which is higher than that of the background are detected, so the threshold is a positive value. If the determination that the target pixel is a contour pixel is made, then the contour information OL generated is “1”. If the determination that the target pixel is not a contour pixel is made, then the contour information OL generated is “0”.

The halftone reproduction process section 5 includes a dither process section 6, a contour processing section 7, and an output determination section 8. The halftone reproduction process section 5 outputs output image data LA obtained by performing a dither process and a contour enhancement process on the γ-processed image data IS.

The dither process section 6 outputs image data SC obtained by performing a multi-level dither process on the image data IS inputted from the γ process section 3.

The multi-level dither process will now be described.

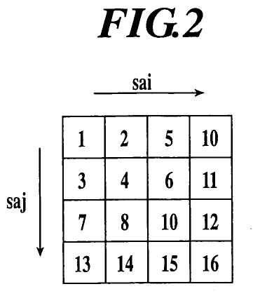

A screen cell including a plurality of elements is set in the dither process section 6. Two different thresholds TH1 and TH2 (TH1<TH2) correspond to each element (cell element) in the screen cell (one cell element corresponds to one pixel). It is assumed that the number in the main scanning direction of the cell elements is M and that the number in the sub scanning direction of the cell elements is N. In an example shown in FIG. 2, M=4 and N=4. Accordingly, the number of elements is sixteen (=4×4) and there are sixteen combinations of two thresholds.

The dither process section 6 receives an image signal according to pixels and finds values sai and saj indicative of the position in the screen cell in FIG. 2 of a pixel inputted by:
sai=i/M (1)
saj=j/N (2)

where i and j are coordinates indicative of the position in the entire image of the pixel inputted. The dither process section 6 specifies a numeric value at the position (sai, saj) as a cell element e corresponding to the pixel.

The dither process section 6 then finds two thresholds TH1 and TH2 corresponding to the cell element e corresponding to the pixel. The thresholds TH1 and TH2 can be obtained by referring to the value of the cell element e found from the screen cell shown in FIG. 2 in look-up tables tb1[M×N] and tb2[M×N] stored in the register 2. This can be written as:
TH1=tb1[e] (3)
TH2=tb2[e] (4)

The look-up tables tb1[M×N] and tb2[M×N] hold thresholds TH1 and TH2 for all the cell elements. The screen cell shown in FIG. 2 includes the sixteen elements, so sixteen numbers are arranged in each of the look-up tables tb1[M×N] and tb2[M×N]. This can be represented by C language codes as:

int tb1[16]={0,16,32,48,64,80,96,112,128,144,160,176,192,208,224,240 };

int tb2[16]={16,32,48,64,80,96,112,128,144,160,176,192,208,224,240,2 55};

The tables tb1 and tb2 are built so that TH1<TH2 will be satisfied.

The dither process section 6 then uses the thresholds TH1 and TH2 obtained for calculating the image data SC obtained by performing the dither process by
SC={(IS−TH1)×255/(TH2−TH1)} (5)

However, SC=0 when SC<0. SC=255 when SC>255.

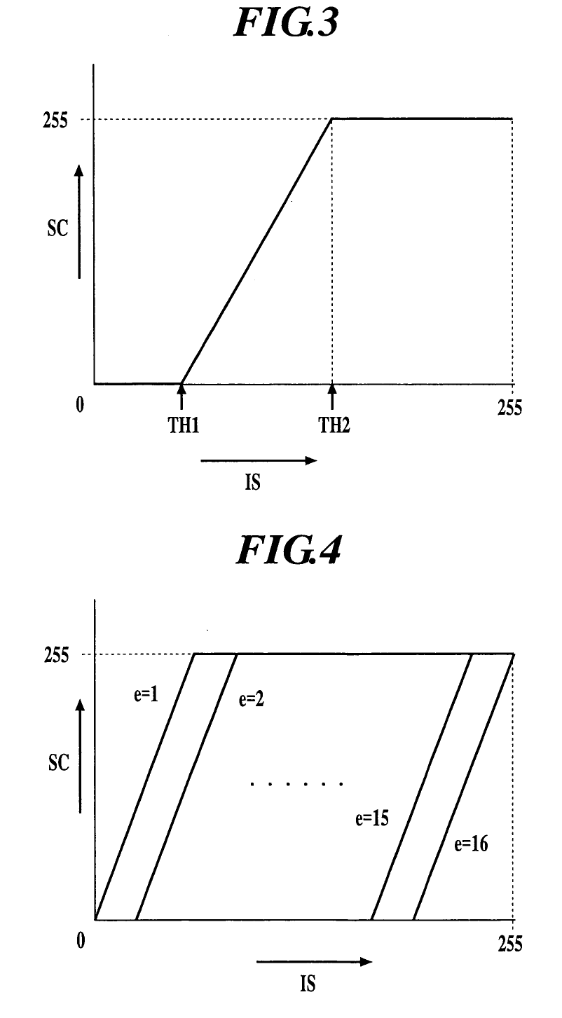

FIG. 3 is a graph showing the relationship between the input pixel value IS and the image data SC obtained by performing the dither process which is indicated by the above equation (5).

The dither process section 6 performs the above process for each pixel.

FIG. 4 is a graph showing that the relationship between the input pixel value IS and the image data SC obtained by performing the dither process differs among the different cell elements. The reason for this is that thresholds TH1 and TH2 differ among the different cell elements.

This embodiment has been described with the case where the multi-level dither process is performed as an example. However, a binary dither process may be performed.

The contour processing section 7 identifies a contour pixel of the object on the basis of the contour information OL inputted from the contour extraction section 4 and outputs image data la obtained by performing a dither process regarding contour enhancement on the contour pixel. In this case, the contour of the object the density of which is higher than that of the background is to be enhanced.

The output determination section 8 determines the output value of each pixel on the basis of the image data SC inputted from the dither process section 6, the image data la inputted from the contour processing section 7, the image data IS inputted from the γ process section 3, and the contour information OL inputted from the contour extraction section 4 and outputs output image data LA.

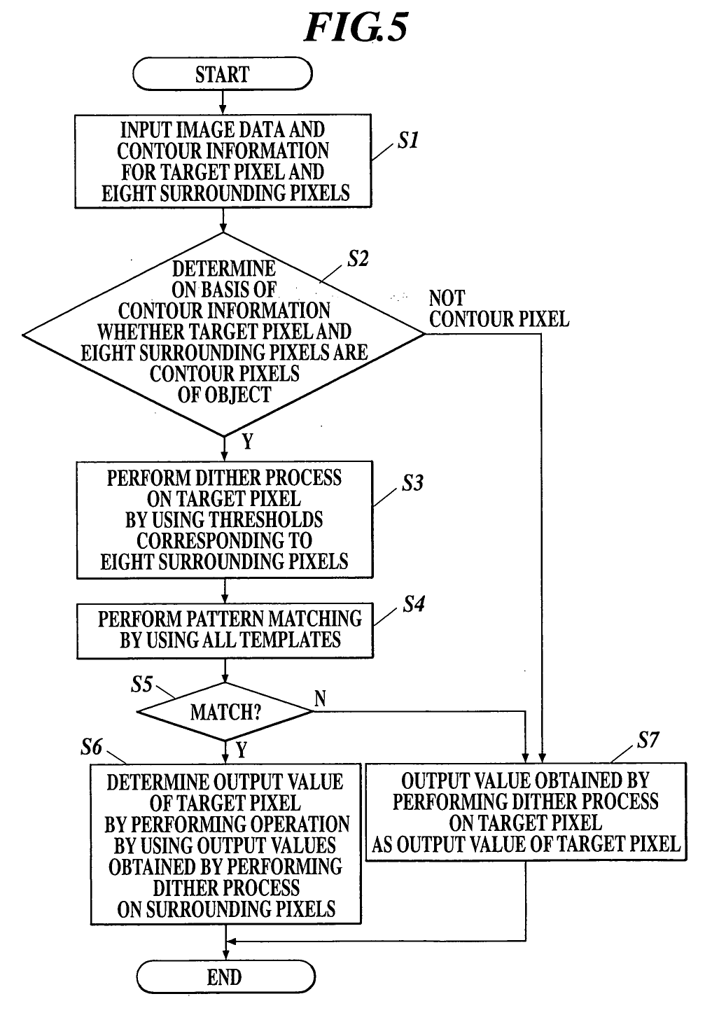

The contour enhancement process performed by the halftone reproduction process section 5 will now be described with reference to a flow chart shown in FIG. 5.

In the contour enhancement process shown in FIG. 5, a target pixel is first set for the image data IS inputted. The dither process section 6 then performs the dither process on the target pixel, calculates the output value SC of the target pixel, and outputs it to the output determination section 8. In parallel with the dither process performed by the dither process section 6, the image data IS (pixel values) for the target pixel set for the image data IS inputted and eight surrounding pixels and the contour information OL for the target pixel and the eight surrounding pixels are inputted to the contour processing section 7 (step S1).

The contour processing section 7 then determines on the basis of the contour information OL whether the target pixel is a contour pixel of the object on which the contour enhancement process is to be performed (step S2). That is to say, if OL=1, then the contour processing section 7 determines that the target pixel is a contour pixel of the object. If OL=0, then the contour processing section 7 determines that the target pixel is not a contour pixel of the object. If the target pixel is not a contour pixel of the object (NOT CONTOUR PIXEL in step S2), then step S7 described later will be performed. If the contour processing section 7 determines that the target pixel is a contour pixel of the object (Y in step S2), then a dither process is performed on the target pixel by using thresholds TH1 and TH2 corresponding to the eight surrounding pixels (“n” of 1 to 8 is used for identifying the eight surrounding pixels).

The thresholds TH1 and TH2 corresponding to the eight surrounding pixels are found in the following way. The coordinates (i, j) of the target pixel in equations (1) and (2) are first replaced by the coordinates (ip, jp) of each of the eight surrounding pixels. The relationships between the coordinates of the target pixel and the eight surrounding pixels are as follows:

ip=i−1 and jp=j−1 for n=1

ip=i and jp=j−1 for n=2

ip=i+1 and jp=j−1 for n=3

ip=i−1 and jp=j for n=4

ip=i+1 and jp=j for n=5

ip=i−1 and jp=j+1 for n=6

ip=i and jp=j+1 for n=7

ip=i+1 and jp=j+1 for n=8

sai and saj obtained are then applied to the screen cell shown in FIG. 2 to find an element value e.

Finally, as shown by equations (3) and (4), the thresholds TH1 and TH2 are obtained by referring to the element value e in the look-up tables tb1 and tb2.

The thresholds TH1 and TH2 found are then substituted in equation (5) to obtain the dither output
la[n]={(IS−TH1)×255/(TH2−TH1)} (8)

la[n] is dither output obtained by using thresholds for a surrounding pixel specified by n. By repeating the above operations, dither outputs la[1] through la[8] for all the surrounding pixels are obtained and are outputted to the output determination section 8 (step S3).

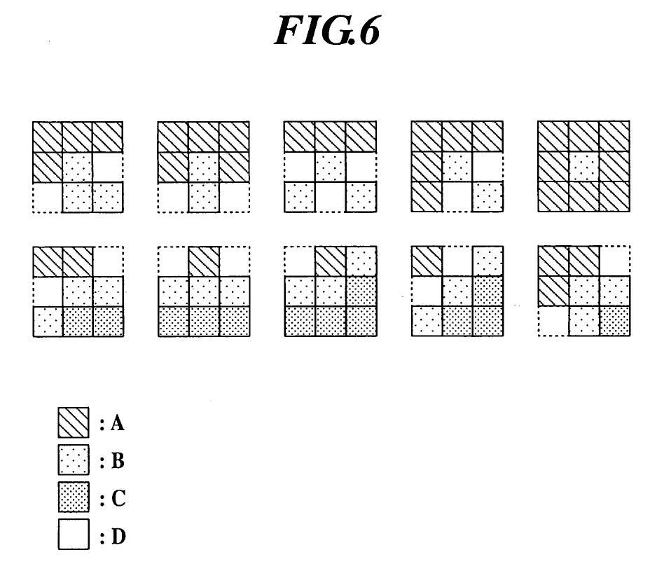

The output determination section 8 performs pattern matching on the target pixel and the eight surrounding pixels on the basis of their pixel values and the contour information OL inputted from the contour extraction section 4 by using templates shown in FIG. 6 (step S4) and determines whether the target pixel and the eight surrounding pixels match at least one template (step S5).

These templates are used for detecting a pixel (referred to as a specific pixel) which is a surrounding pixel for the target pixel, being a contour pixel, and which is outside the object. In the templates shown in FIG. 6, a pixel indicated by A is a specific pixel to be detected, a pixel indicated by B is a contour pixel of the object, a pixel indicated by C is a pixel inside a contour pixel of the object, and a pixel indicated by D is a surrounding pixel for the target pixel and is outside the object.

At the time of performing the matching, each template is placed so that the target pixel will be in the center of it. Each time a matching process is performed, each template is rotated by 90 degrees. That is to say, if all of the ten templates shown in FIG. 6 are used, a matching process is performed on one target pixel forty times.

If the conditions that (1) all surrounding pixels corresponding to a pixel indicated by B are contour pixels and that (2) the pixel value of a contour pixel is a certain value or more greater than that of a surrounding pixel corresponding to a pixel indicated by D or A are both met, then the determination that the target pixel and the eight surrounding pixels match a template is made. Condition (2) is required for performing a contour enhancement process only on an object the density of which is higher than that of a background. Whether condition (1) is met is determined on the basis of the contour information OL. Whether condition (2) is met is determined by comparing the pixel value of the target pixel with the pixel value of a surrounding pixel corresponding to a pixel indicated by D or A.

If the determination that the target pixel and the eight surrounding pixels match at least one template is made (Y in step S5), then the output determination section 8 performs a predetermined operation for a surrounding pixel [n] corresponding to a pixel in the template indicated by C, that is to say, for a surrounding pixel [n] detected as a specific pixel by using an output value la[n] calculated by the contour processing section 7 and determines an output value calculated by the operation as an output value LA of the target pixel (step S6).

In this embodiment, an output value la[n] that is the greatest of output values la[n] of specific pixels is calculated and is determined as the output value LA. By outputting the maximum value, the density of a contour portion can be increased and contour enhancement can be performed.

Another operation may be performed. For example, the sum of output values la[n] of specific pixels may be determined as the output value LA. The weighted average of output values la[n] of specific pixels may be calculated. By using these operation methods, the output density of a contour portion can be controlled.

If the target pixel and the eight surrounding pixels do not match a template (N in step S5), then an output value SC obtained by performing an ordinary dither process by using the thresholds for the target pixel is determined as an output value LA of the target pixel (step S7).

The above process is performed on all pixels included in the image data IS inputted and an output value LA determined for each pixel is outputted as final output image data LA.

An example of output obtained by the above contour enhancement process will now be described.

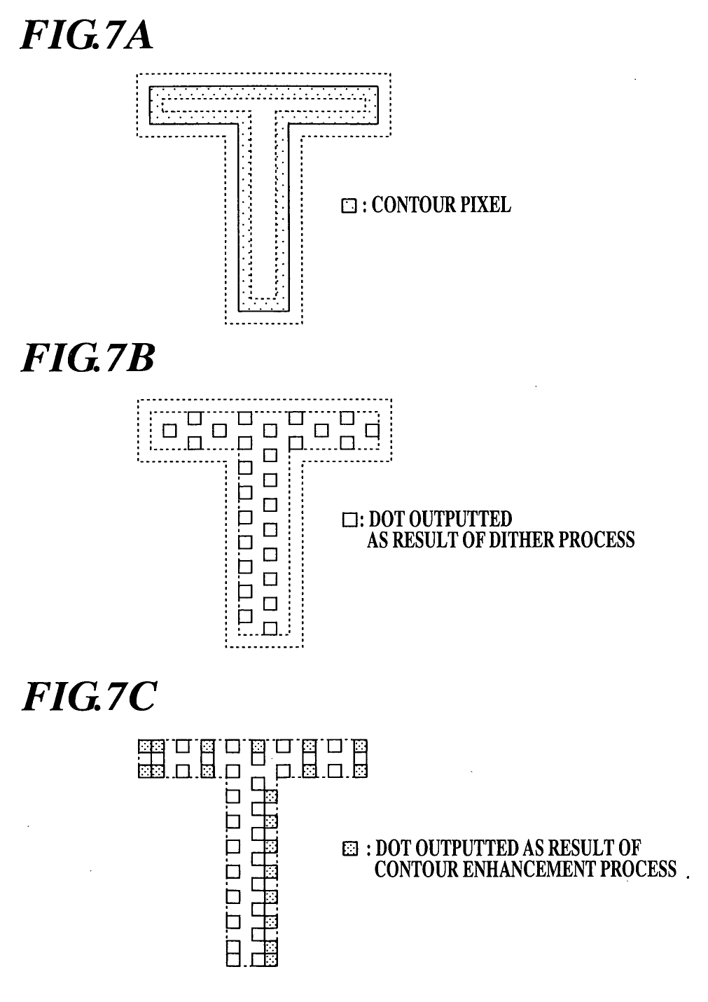

The case where an object “T” (area enclosed by a solid line) shown in FIG. 7A is outputted will be described. If the above contour enhancement process is not performed and an ordinary dither process is performed on this object, then an output result shown in FIG. 7B is obtained as image data SC. In a horizontal line of the output result “T,” dots are outputted in some portions along the contour line, but dots are not outputted in others along the contour line. That is to say, a jaggy phenomenon has occurred. In a vertical line of the output result “T,” thinning has occurred.

However, if the contour enhancement process according to the present invention is performed, then an output value la[n] that is the greatest of output values la[n] obtained by performing a dither process by using thresholds for specific pixels (pixels which are in an area outside the object “T” enclosed by dotted lines shown in FIG. 7B) detected is outputted for each contour pixel (see FIG. 7A). Accordingly, an output result shown in FIG. 7C is obtained. As shown in FIG. 7C, dots are outputted in contour pixel portions of the object and contour enhancement succeeds. Moreover, by performing contour enhancement, the jaggy is eliminated and the thinning is lessened.

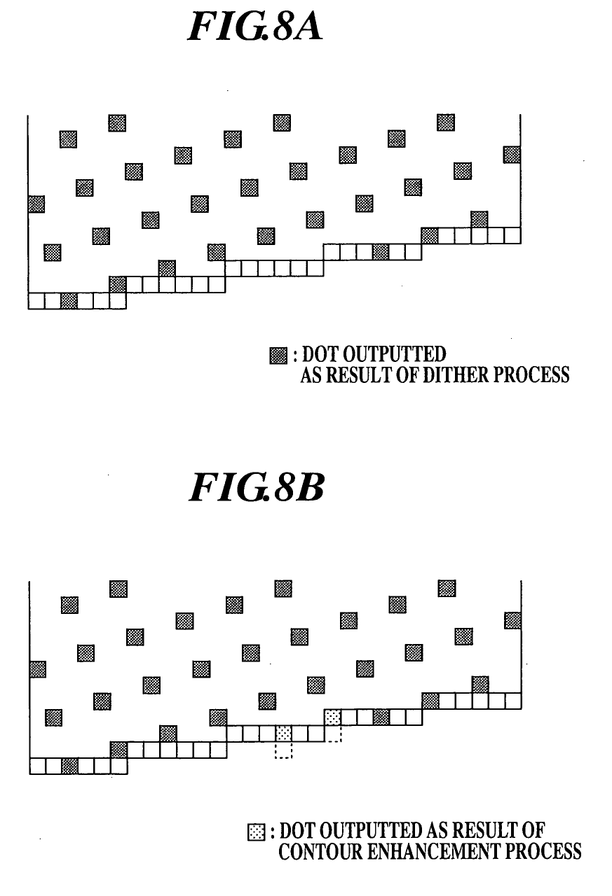

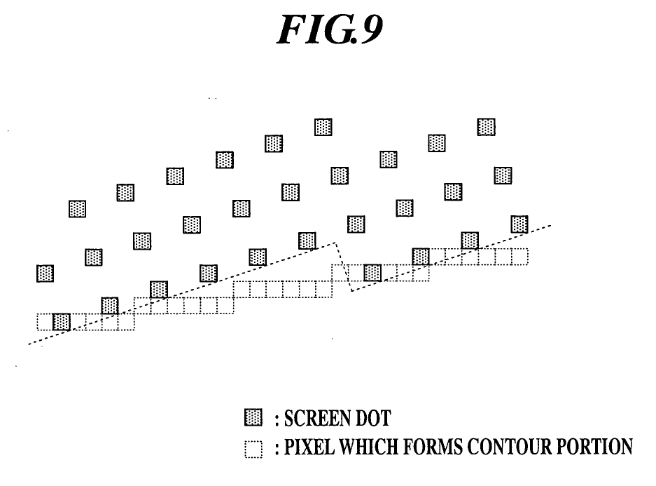

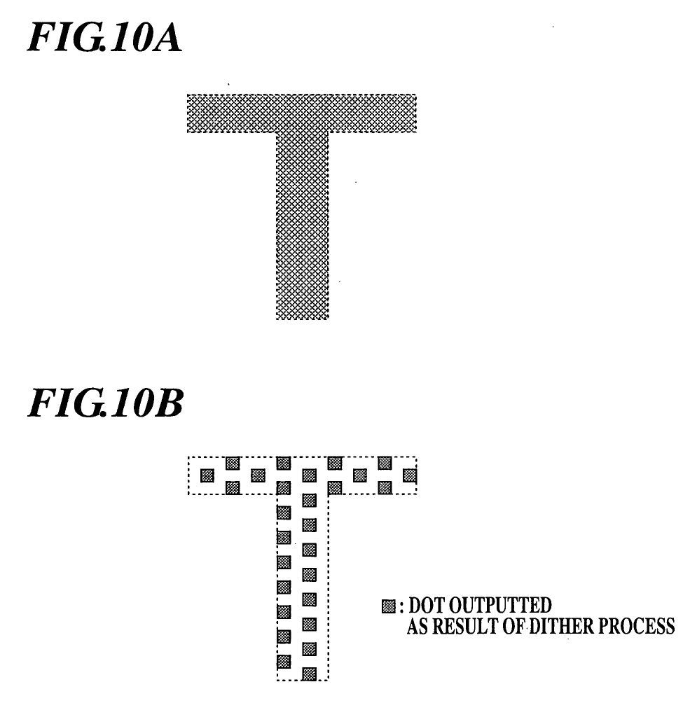

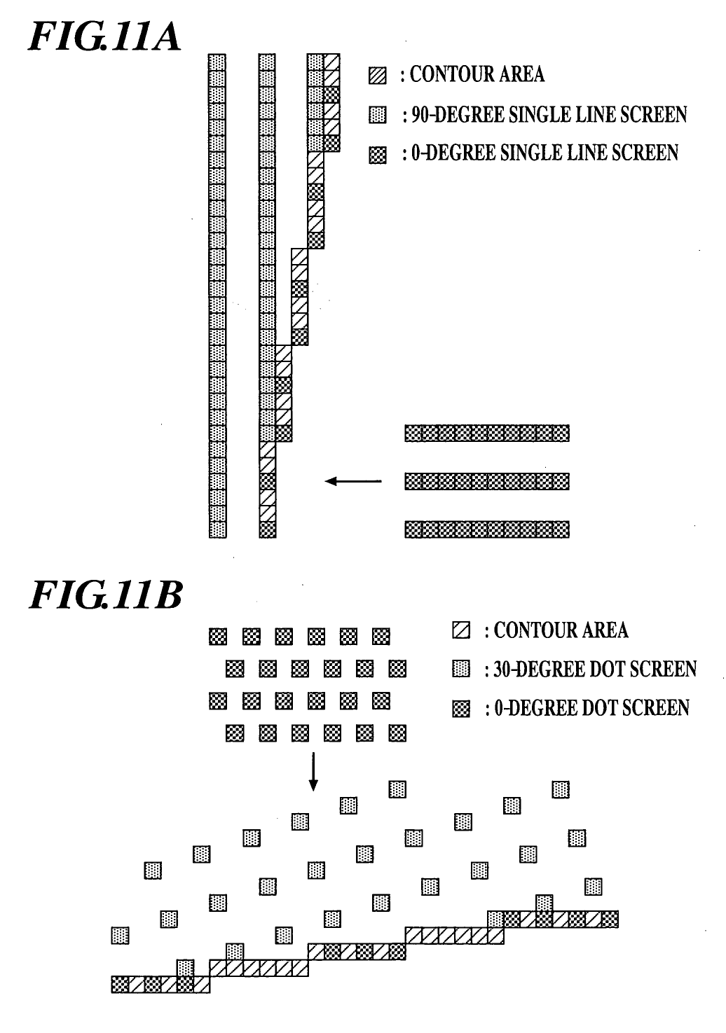

FIG. 8A shows an output result obtained by performing a dither process on a large letter in a halftone. The distance between dots outputted as a result of the dither process is long in an area where density is uniformly low. Accordingly, a jaggy appears near the contour.

As shown in FIG. 8B, however, dots are outputted in contour portions if the contour enhancement process is performed. Therefore, the appearance of a jaggy can be restrained effectively.

As has been described in the foregoing, in this embodiment of the present invention an output value which is the greatest of output values obtained by performing a dither process by using thresholds for a dither process corresponding to pixels outside an object is considered as an output value of a target pixel, being a contour pixel. As a result, a dot output rate in contour pixel portions can be raised. By performing, for example, contour enhancement, the contour of the object can be properly represented even after the dither process. This prevents degradation in image quality caused by the appearance of a jaggy, thinning, or the like and improves the apparent resolution of the object.

In addition, dots are outputted in contour pixel portions by the contour enhancement process, so periodicity caused by a uniform dither process can be broken. This prevents periodic interference and avoids degradation in image quality caused by, for example, the appearance of moire. Intervals between dots are long especially in a low-density area. However, dots outputted as a result of the contour enhancement process are not touching dots which have been outputted as a result of an ordinary dither process, so degradation in image quality caused by a local increase in density at the printing stage can be prevented. Moreover, even if the angle of the contour of the object differs from the screen angle of a dither screen, periodicity caused by the dither process can be broken. Therefore, degradation in image quality caused by periodicity can be reduced.

Furthermore, whether the target pixel is a contour pixel is determined on the basis of the pixel value of the target pixel and the pixel value of a surrounding pixel. Therefore, whether the target pixel is a contour pixel which forms part of the contour of the object can be determined with not only information regarding the target pixel but also information regarding the surrounding pixel taken into consideration.

In addition, the contour enhancement process can be performed only if it is necessary to perform a dither process on the contour.

Moreover, thresholds for a dither process corresponding to a plurality of surrounding pixels outside the object are used for determining the output value of the target pixel. As a result, the output value can be determined according to circumstances and a more natural contour can be reproduced. The extent to which the contour is enhanced can be controlled by an operation.

In the above embodiment the contour of the object is enhanced. However, if a multi-level dither method is adopted, a process for decreasing the density of pixels in a contour portion can be performed after the above process to avoid unnecessary enhancement of the contour portion.

In the process performed in the above embodiment, thresholds for a cell element corresponding to a pixel outside the object are applied to the target pixel by shifting the screen cell with respect to the target pixel according to the template patterns. However, the present invention is not limited to such a case. When a dither process is performed, the position of the target pixel may be shifted instead of shifting the screen cell. An example of a process in which the position of a target pixel is shifted is as follows.

(1) First, a process for thickening an object outward is performed and a dither process is performed on the thickened object.

(2) An output value of a pixel corresponding to a thickened portion which is obtained as a result of the dither process is then compared with an output value of a contour pixel of the original object.

(3) If the output value of the pixel corresponding to the thickened portion which is obtained as a result of the dither process is greater than the output value of the contour pixel of the original object, then this output value is used as the output value of the contour pixel of the original object and the thickened object is returned to the original size (thinned).

The present application is based on Japanese Patent Application No. Tokugan 2005-177704 filed with Japan Patent Office on Jun. 17, 2005.

What is claimed is:

1. An image processing method comprising:
discriminating whether a target pixel of an image to be processed is a contour pixel which is part of a contour of an object; and
determining, in case of discriminating that the target pixel is a couture pixel, an output value of the target pixel by referring to an output value that is obtained by applying a threshold for a dither process corresponding to a pixel outside the object to a pixel value of the target pixel.

2. The method of claim 1, wherein in the discriminating, whether the target pixel is a contour pixel which constitutes a part of the contour of the object or not is discriminated based on the pixel value of the target pixel and a pixel value of a surrounding pixel for the target pixel.

3. The method of claim 1, wherein in the determining, an output value is obtained by applying a threshold for a dither process corresponding to the target pixel and is determined as the output value of the target pixel, in the case of discriminating that the target pixel is not a contour pixel.

4. The method of claim 1, wherein in the determining,
a plurality of output values are obtained by applying thresholds for a dither process corresponding to a plurality of pixels outside the object, and
an output value of the target pixel is determined by referring to an operation result obtained by a simple mean value, a weighted mean value or a maximum value of the plurality of output values, or combination thereof.

5. The method of claim 1, further comprising inputting an image identification signal indicative of a type of the image including the target pixel, wherein
the determining is performed only on a target pixel for which the image identification signal is a specific signal.

6. The method of claim 1, further comprising inputting the pixel value of the target pixel, wherein
the determining is performed only when the pixel value of the target pixel is greater than or equal to a certain value.

7. A recording medium storing an image processing program for causing a computer to execute a method comprising:
discriminating whether a target pixel of an image to be processed is a contour pixel which is part of a contour of an object; and
determining, in case of discriminating that the target pixel is a couture pixel, an output value of the target pixel by referring to an output value that is obtained by applying a threshold for a dither process corresponding to a pixel outside the object to a pixel value of the target pixel and referring to the output value.

8. The program of claim 7, wherein in the discriminating, whether the target pixel is a contour pixel which constitutes a part of the contour of the object is discriminated based on the pixel value of the target pixel and a pixel value of a surrounding pixel for the target pixel.

9. The program of claim 7, wherein in the determining, an output value is obtained by applying a threshold for a dither process corresponding to the target pixel and is determined as the output value of the target pixel, in the case of discriminating that the target pixel is not a contour pixel.

10. The program of claim 7, wherein in the determining,
a plurality of output values are obtained by applying thresholds for a dither process corresponding to a plurality of pixels outside the object, and
an output value of the target pixel is determined by referring to an operation result obtained by a simple mean value, a weighted mean value or a maximum value of the plurality of output values, or combination thereof.

11. The program of claim 7, wherein the method further comprises inputting an image identification signal indicative of a type of the image including the target pixel,
wherein the determining is performed only on a target pixel for which the image identification signal is a specific signal.

12. The program of claim 7, wherein the method further comprises inputting the pixel value of the target pixel,
wherein the determining is performed only when the pixel value of the target pixel is greater than or equal to a certain value.
